(19) United States
(12) Patent Application Publication
(10) Pub. No.: US 2011/0114747 A1
(43) Pub. Date: May 19, 2011

(54) System for the biological treatment of HVAC units

(75) Inventor: Rudiger Cruysberghs, Brussels (BE)

(73) Assignee: RUDIGER CRUYSBERGHS, BRUSSEL (BE)

(21) Appl. No.: 12/461,443

(22) Filed: Aug. 12, 2009

Related U.S. Application Data
(60) Provisional application No. 61/192,495, filed on Sep. 19, 2008.

(30) Foreign Application Priority Data
Jun. 25, 2008 (BE) BE2008/0348

(51) Int. Cl. A01G 27/00

(52) U.S. Cl. 239/70

(57) ABSTRACT

Spraying unit for the biological treatment of an HVAC unit to control unwanted odours, consisting of a dispenser with an internal pressure medium and at least one nozzle for the manual or automatic atomisation of non-pathogenic bacteria and whereby the dispenser is entirely contained in a space of the HVAC unit.

The present invention concerns a system allowing both preventive and curative treatments of HVAC units and particularly air-conditioning units against odours resulting from microorganism degradation processes.

The invention particularly concerns a dispenser whereby a mixture of non-pathogenic bacteria is atomised in a part of the air-conditioning unit, using a spraying system to atomise non-pathogenic bacteria of the Bacillus genus in such a manner that a culture with the above-mentioned bacteria takes up the medium for odour-forming microorganisms.

A HVAC (heating, ventilating and air conditioning) unit and particularly an air-conditioning unit usually consists of a circuit in which a coolant is moved under high pressure, and includes a compressor, a condenser, a filter, an expansion valve, a fan and an evaporator. The filter concerns an air treatment filter capturing very fine dust particles. In addition, it is fitted with an odour-eliminating active carbon filter.

On the other hand, photocatalytic odour-eliminating filters with an antibacterial effect also exist.

Anyhow, cultures of odour-forming microorganisms may developed in air-conditioning units, both in vehicles and in buildings, such as pathogenic bacteria and fungi. Buildings are understood to mean houses, companies, hospitals, office buildings, schools, sports halls, flats, . . .

It are mainly the degradation products of these microorganisms which result in unpleasant odours. In addition, various microorganisms are pathogens such as E. coli and S. aureus and cause allergic reactions. Due to the favourable abiotic ambient factors, such as the temperature and humidity in air-conditioning units, cultures of microorganisms can rapidly propagate there. Consequently, ventilation systems where a condensation liquid is formed are a good medium for microorganisms. It has been determined that there is an increased risk of a microorganism colony developing mainly in the evaporator area.

According to the state of the art, systems are used which are mainly aimed at destroying the microorganisms.

A first technique uses ozone or a combination of ozone with UV radiation. In accordance with US2006/0104858 a combination of hydrogen peroxide and UV radiation is used.

FR2837106 sprays fungicide-containing active foam into a part of the air-conditioning unit after the removal of a pollen filter.

The injection of solvents to clean air-conditioning units is known from U.S. Pat. No. 5,911,742 or from EP842801. In U.S. Pat. No. 5,911,742 detergents, cleaning water, aromatics, chemicals, deodorants, fungicides, . . . are used for instance. The system contains a nozzle which can be connected to an external spray can.

WO8810122 uses a spray with a biocide like Melaleuca oil. The aforesaid systems use detergents, fungicides, cleaning products to eliminate the microorganisms. There is an increased risk that residues of these products remain in the space inside the air-conditioning unit.

In addition, the use of environmentally hazardous detergents or cleaning agents is best avoided. On the other hand, it is aesthetically not recommended to have an external vessel in the passenger compartment of a vehicle.

In other instances the air-conditioning unit is cleaned by introducing cleaning products from the outside; as a result, the specific spots are not always reached.

Furthermore, some units use various parts which make the entire system rather complex and relatively expensive to install.

Our invention is thus aimed at remedying the aforesaid drawbacks by means of a spraying unit, consisting of a dispenser with an internal pressure medium in an HVAC or particularly by ensuring that the spraying unit is preferably contained entirely in the air-conditioning unit and whereby non-pathogenic bacteria are also used to keep the unit free of harmful and odour-forming microorganisms.

Our invention thus includes a dispenser with at least one nozzle, preferably between a fan and an evaporator. A mixture of non-pathogenic bacteria of the Bacillus genus is dispensed in an HVAC, and particularly an air conditioning unit.

The first property of our invention thus is that no environmentally hazardous products are used. Non-harmful bacteria (GRAS), e.g. of the Bacillus genus, are atomised to keep cultures of pathogenic and odour-forming bacteria from an HVAC unit.

Since the dispenser is integrated in an air-conditioning unit according to our invention, there are no harmful effects on the passenger compartment of vehicles, or the aesthetic nature of the air-conditioning unit is not affected. In addition, the spraying unit can be easily activated, without having to disassemble the air-conditioning unit for cleaning, or without having to work with loose spray cans and hoses.

Finally, the invention is characterised by the possibility to activate the spraying unit both manually and automatically. Using a timer the spraying unit can be activated when desired.

The invention is detailed below. A spraying unit consists of a dispenser, containing an internal pressure medium, a control valve and at least one nozzle. The dispenser is installed in an HVAC unit and particularly in an air-conditioning unit. The dispenser is preferably placed in a holder, like a spray can. This holder allows clamping of a dispenser. The dispenser is preferably installed in such a manner that, when atomising, the wind circulation of the fan will spread its contents, particularly in the evaporator area. In HVAC units in buildings the non-pathogenic bacteria will spread in the HVAC ducts through turbulence.

A possible method is to install a coupling on the dispenser of the spraying unit, to allow connection of several nozzles. This coupling for instance allows the connection of a pipe, such as a flexible plastic hose or a stiff tube. This method allows the installation of various nozzles at discrete places in the HVAC area. These nozzles preferably use control valves. The control valves are closed; when the spraying unit is activated the flexible hose or stiff tube fills with product. If the hose or tube is entirely filled, the valves are activated and the product is dispensed in the intended locations through the nozzles. In addition, it is possible to close certain valves in the intended locations. The flexible hose or stiff tube, fitted with various nozzles, can be installed in the space in accordance with the desired configuration, to allow atomizing in specific locations. In case of buildings, it is self-evident that the hose or tube can be installed in the ducts of an HVAC unit.

The dispenser is activated by means of a manually or automatically set control mechanism. In case of manual control, an activation mechanism allows to activate the control valve of the dispenser and to atomise the contents thereof.

In case of automatic control, a timer is used which can be set in accordance with a specific time interval and using an electromechanical activation mechanism.

The product's composition consists of a mixture of non-pathogenic bacteria of the Bacillus genus. This type of bacteria are considered non-harmful (GRAS).

The mixture consists of the following non-pathogenic bacteria, i.e. Bacillus amyloliquefaciens, Bacillus subtilis, Bacillus liceniformis, Bacillus pumilis and Bacillus megaterium.

By atomising non-pathogenic bacteria in an HVAC unit or particularly an air-conditioning unit, the development of harmful bacteria is curtailed. Since the non-pathogenic bacteria use the available media, such as a condensation liquid, and proceed to form a colony, the other microorganisms deprived of their food source. This can be considered a form of antagonism, whereby the odour-forming microorganisms are repelled by non-pathogenic bacteria which take up the available medium.

1. A spraying unit to treat an HVAC unit consisting of a dispenser, fitted with an internal pressure medium and at least one nozzle, a control valve and an activation mechanism and characterised by the dispenser being installed in a space of the HVAC unit and whereby non-pathogenic bacteria are atomised.

2. A spraying unit to treat an HVAC unit in accordance with claim 1 and characterised by the fact that the dispenser is placed in a holder.

3. A spraying unit to treat an HVAC unit in accordance with one of the above-mentioned claims and characterised by the fact that the dispenser is installed in such a manner that, when atomising, the mixture of non-pathogenic bacteria is distributed by the HVAC fan and mainly in the HVAC evaporator area.

4. A spraying unit to treat an HVAC unit in accordance with the above-mentioned claims and characterised by the fact that the dispenser is fitted with a coupling to connect a flexible hose or a stiff tube.

5. A spraying unit to treat an HVAC unit in accordance with claim 4 and characterised by the fact that the hose or tube are fitted with various nozzles in discrete places.

6. A spraying unit to treat an HVAC unit in accordance with claim 5 and characterised by the fact that the nozzles are fitted with individual control valves.

7. A spraying unit in accordance with claims 1-6 and characterised by the fact that the spraying unit is activated manually or automatically.

8. A spraying unit in accordance with claim 7 and characterised by the fact that the automatic control is fitted with a timer.

9. A spraying unit to treat an HVAC unit in accordance with claims 1-8 and characterised by the fact that the non-pathogenic bacteria are of the Bacillus genus.

10. A spraying unit to treat an HVAC unit in accordance with claim 9 and characterised by the fact that the dispenser contains a mixture of Bacillus amyloliquefaciens, Bacillus subtilis, Bacillus liceniformis, Bacillus pumilis and Bacillus megaterium.

11. A spraying unit to treat an HVAC unit in accordance with the above-mentioned claims and characterised by the fact that it concerns an HVAC unit in a building or a vehicle.
